(19) United States
(12) Patent Application Publication
(10) Pub. No.: US 2004/0246185 A1
(43) Pub. Date: Dec. 9, 2004

(54) Multi-band improvements to a monopole helical

(75) Inventor: Angus Macqueen, Chandler, AZ (US)

Correspondence Address: LADAS & PARRY, 26 WEST 61ST STREET, NEW YORK, NY, 10023, US

(73) Assignee: GALTRONICS LTD.

(21) Appl. No.: 10/459,305

(22) Filed: Jun. 11, 2003

(30) Foreign Application Priority Data
Jun. 4, 2003 (IL) IL/03/00471

(51) Int. Cl. H01Q 1/36; H01Q 1/24

(52) U.S. Cl. 343/702; 343/895

(57) ABSTRACT

An antenna including a base, a windback coil including a longitudinal portion and a coil portion, mechanically mounted onto the base and electrically coupled thereto, and a second coil mechanically mounted onto the base and electrically coupled thereto.

### REFERENCE TO CO-PENDING APPLICATIONS

The present invention is related to and claims priority from U.S. Provisional Patent Application Ser. No. 60/386,890, filed Jun. 6, 2002 and entitled: “MULTI-BAND IMPROVEMENTS TO A MONOPOLE HELICAL”.

### FIELD OF THE INVENTION

The present invention relates to antennas generally and more particularly to helical antennas.

### BACKGROUND OF THE INVENTION

Windback helical antennas are known in the patent literature, inter alia from applicant/assignee's U.S. Pat. No. 6,075,488.

### SUMMARY OF THE INVENTION

The present invention seeks to provide an improved helical antenna.

There is thus provided in accordance with a preferred embodiment of the present invention an antenna including a base, a windback coil including a longitudinal portion and a coil portion, mechanically mounted onto the base and electrically coupled thereto, and a second coil mechanically mounted onto the base and electrically coupled thereto. Preferably, the windback coil is mechanically mounted onto the base and electrically coupled thereto at an end portion of the longitudinal portion. Additionally, the antenna also includes an antenna cover mounted onto the base and covering the windback coil and the second coil. Preferably, the second coil is resonant at a frequency band which is higher than at least one frequency band at which the windback coil is resonant.

In accordance with another preferred embodiment of the present invention the base is integrally formed of metal and includes an anchor shaft suitable for removable mechanical mounting and secure electrical connection to a communication device, a threaded portion suitable for engagement with a suitably threaded mounting socket on the communication device, and a dual feed point portion. The dual feed point portion defines a central feed point bore for receiving an end portion of the longitudinal portion of the windback coil, and a peripheral recess for receiving an end portion of the second coil.

### BRIEF DESCRIPTION OF THE DRAWINGS

The present invention will be understood and appreciated more fully from the following detailed description, taken in conjunction with the drawings in which:

FIG. 1 is an exploded view illustration of an antenna constructed and operative in accordance with a preferred embodiment of the present invention;

FIG. 2 is an assembled view illustration of the antenna of FIG. 1;

FIG. 3 is a sectional view illustration of the antenna of FIG. 2; and

FIG. 4 is a pictorial illustration of the antenna of FIGS. 1-3.

### DETAILED DESCRIPTION OF A PREFERRED EMBODIMENT

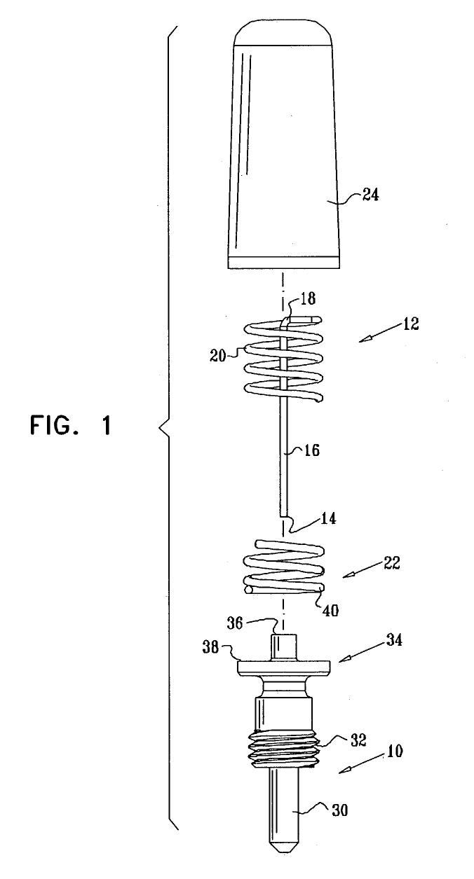

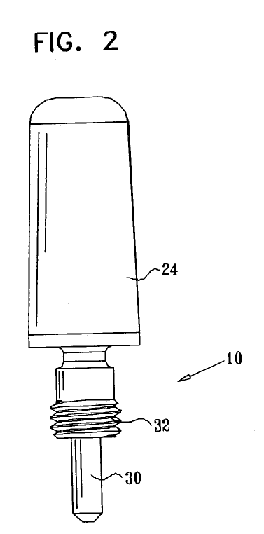

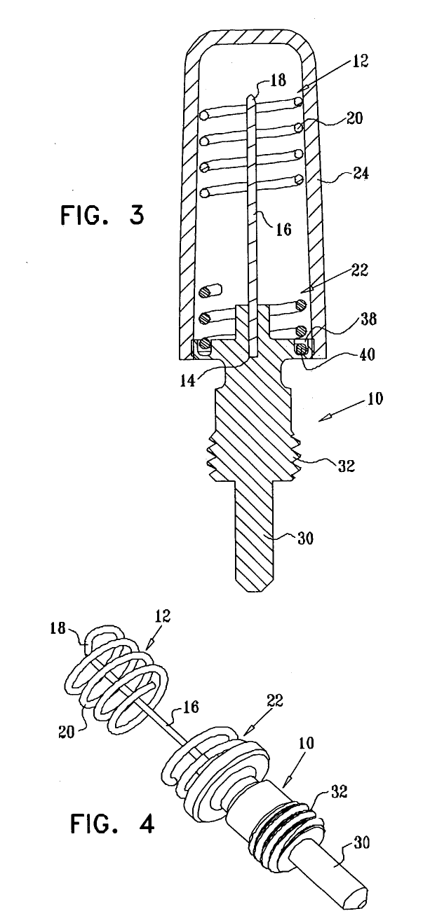

Reference is now made to FIGS. 1-4 which illustrate an antenna constructed and operative in accordance with a preferred embodiment of the present invention. As seen in FIGS. 1-4, the antenna comprises a base 10, formed of an electrically conductive material, such as a metal.

A windback coil 12, formed of an electrically conductive material, such as a metal, is mechanically mounted onto base 10 and is electrically coupled thereto at an end portion 14 of a longitudinal portion 16 thereof, which longitudinal portion is coupled at a second end 18 thereof to a coil portion 20.

A second coil 22, formed of an electrically conductive material, such as a metal, is mechanically mounted onto base 10 and is electrically coupled thereto. The second coil 22 is preferably resonant in a higher band than the windback coil 12. Alternatively, the second coil 22 is resonant in a similar band or a lower band than the windback coil 12. Typical resonance bands for the windback coil 12 are 800 MHz and 1900 MHz, and a typical resonance band for the second coil 22 is 1575 MHz.

An antenna cover 24, preferably formed of a dielectric material, such as plastic, is preferably fixed onto base 10, covering windback coil 12 and second coil 22.

Base 10 preferably is of generally conventional construction in that it includes an anchor shaft 30 for removable mechanical mounting and secure electrical connection to a communication device, such as a cellular telephone (not shown). Disposed above anchor shaft 30 is a threaded portion 32 for threaded engagement with a suitably threaded mounting socket on the communication device.

Integrally formed with the remainder of the base 10 is a dual feed point portion 34 which defines a central feed point bore 36 for receiving end portion 14 of the longitudinal portion 16 of the windback coil 12. Dual feed point portion 34 also defines a peripheral recess 38 for receiving an end portion 40 of second coil 22. Tight mechanical engagement and secure electrical connections between the base 10 and end portions 14 and 40 of windback coil 12 and second coil 22 respectively is preferably provided by crimping.

It will be appreciated by persons skilled in the art that the present invention is not limited to what has been particularly shown and described hereinabove. Rather the scope of the present invention includes both combinations and subcombinations of the various features described hereinabove as well as modifications and variations thereof as would occur to a person of skill in the art upon reading the foregoing specification and which are not in the prior art.

1. An antenna comprising:
a base;
a windback coil including a longitudinal portion and a coil portion, mechanically mounted onto said base and electrically coupled thereto; and
a second coil mechanically mounted onto said base and electrically coupled thereto.

2. An antenna according to claim 1 and wherein said windback coil is mechanically mounted onto said base and electrically coupled thereto at an end portion of said longitudinal portion.

3. An antenna according to claim 1 and also comprising an antenna cover mounted onto said base and covering said windback coil and said second coil.

4. An antenna according to claim 2 and also comprising an antenna cover mounted onto said base and covering said windback coil and said second coil.

5. An antenna according to claim 1 and wherein said second coil is resonant at a frequency band which is higher than at least one frequency band at which said windback coil is resonant.

6. An antenna according to claim 2 and wherein said second coil is resonant at a frequency band which is higher than at least one frequency band at which said windback coil is resonant.

7. An antenna according to claim 3 and wherein said second coil is resonant at a frequency band which is higher than at least one frequency band at which said windback coil is resonant.

8. An antenna according to claim 4 and wherein said second coil is resonant at a frequency band which is higher than at least one frequency band at which said windback coil is resonant.

9. An antenna according to claim 1 and wherein said base is integrally formed of metal and includes:
an anchor shaft suitable for removable mechanical mounting and secure electrical connection to a communication device;
a threaded portion suitable for engagement with a suitably threaded mounting socket on said communication device; and
a dual feed point portion which defines:
a central feed point bore for receiving an end portion of said longitudinal portion of said windback coil; and
a peripheral recess for receiving an end portion of said second coil.

10. An antenna according to claim 2 and wherein said base is integrally formed of metal and includes:
an anchor shaft suitable for removable mechanical mounting and secure electrical connection to a communication device;
a threaded portion suitable for engagement with a suitably threaded mounting socket on a communication device; and
a dual feed point portion which defines:
a central feed point bore for receiving said end portion of said longitudinal portion of said windback coil; and
a peripheral recess for receiving an end portion of said second coil.

11. An antenna according to claim 3 and wherein said base is integrally formed of metal and includes:
an anchor shaft suitable for removable mechanical mounting and secure electrical connection to a communication device;
a threaded portion suitable for engagement with a suitably threaded mounting socket on a communication device; and
a dual feed point portion which defines:
a central feed point bore for receiving an end portion of said longitudinal portion of said windback coil; and
a peripheral recess for receiving an end portion of said second coil.

12. An antenna according to claim 4 and wherein said base is integrally formed of metal and includes:
an anchor shaft suitable for removable mechanical mounting and secure electrical connection to a communication device;
a threaded portion suitable for engagement with a suitably threaded mounting socket on a communication device; and
a dual feed point portion which defines:
a central feed point bore for receiving said end portion of said longitudinal portion of said windback coil; and
a peripheral recess for receiving an end portion of said second coil.

13. An antenna according to claim 5 and wherein said base is integrally formed of metal and includes:
an anchor shaft suitable for removable mechanical mounting and secure electrical connection to a communication device;
a threaded portion suitable for engagement with a suitably threaded mounting socket on a communication device; and
a dual feed point portion which defines:
a central feed point bore for receiving an end portion of said longitudinal portion of said windback coil; and
a peripheral recess for receiving an end portion of said second coil.

14. An antenna according to claim 6 and wherein said base is integrally formed of metal and includes:
an anchor shaft suitable for removable mechanical mounting and secure electrical connection to a communication device;
a threaded portion suitable for engagement with a suitably threaded mounting socket on a communication device; and
a dual feed point portion which defines:
a central feed point bore for receiving said end portion of said longitudinal portion of said windback coil; and
a peripheral recess for receiving an end portion of said second coil.

15. An antenna according to claim 7 and wherein said base is integrally formed of metal and includes:
an anchor shaft suitable for removable mechanical mounting and secure electrical connection to a communication device;
a threaded portion suitable for engagement with a suitably threaded mounting socket on a communication device; and
a dual feed point portion which defines:
a central feed point bore for receiving an end portion of said longitudinal portion of said windback coil; and
a peripheral recess for receiving an end portion of said second coil.

16. An antenna according to claim 8 and wherein said base is integrally formed of metal and includes:
an anchor shaft suitable for removable mechanical mounting and secure electrical connection to a communication device;
a threaded portion suitable for engagement with a suitably threaded mounting socket on a communication device; and
a dual feed point portion which defines:
a central feed point bore for receiving said end portion of said longitudinal portion of said windback coil; and
a peripheral recess for receiving an end portion of said second coil.
